(19) United States
(12) Patent Application Publication
(10) Pub. No.: US 2002/0090063 A1
(43) Pub. Date: Jul. 11, 2002

(54) Voiced mail with special alert feature

(76) Inventor: Joseph Bach, Morgan Hill, CA (US)

Correspondence Address: JOSEPH BACH, 17460 LAKEVIEW DRIVE, MORGAN HILL, CA, 95037, US

(21) Appl. No.: 10/035,272

(22) Filed: Jan. 3, 2002

Related U.S. Application Data
(62) Division of application No. 09/156,270, filed on Sep. 16, 1998.

(51) Int. Cl. H04M 1/64

(52) U.S. Cl. 379/67.1; 379/88.12

(57) ABSTRACT

When a voice mail system receives and records a message, it activates its own alarm, normally in the form of an LED. It then contacts an assigned mobile unit and sends a code to the mobile unit directing it to activates the mobile unit's own alarm, normally also in the form of an LED or an LCD.

### BACKGROUND OF THE INVENTION

1. Field of the Invention

The invention relates to voice mail systems and, more particularly, to a voice mail system capable of activating an alert in a secondary, e.g., mobile, communication device. This is a Divisional of Ser. No. 09/156, 270.

2. Description of Related Art

Voice mail systems are well known in the art. A notable feature of such systems is that an alert, generally in the form of an LED, is activated when a message is received by the system, and is deactivated when the message is replayed by the user.

Pagers are also well known in the art, including cellular phones having paging feature. A recent advancement in the art provides a link between the voice mail system and an assigned pager. Specifically, when one places an urgent call and the call is answered by the voice mail system, one has the option of having the voice mail system page the system's owner. According to one such a system, the caller can either leave a message (which will not trigger the paging), or, if one needs to get in contact with the owner urgently, dial one's own number so that the system would page the system's owner and send the number of the calling party. Thus, the owner's pager would ring or vibrate and display the number of the calling party. This advancement is very useful for people who spend much time out of the office, but must be able to stay in contact with customers, employees etc.

However, the current system still has a drawback. Specifically, when the calling person simply leaves a message in the voice mail system, the system's owner cannot find that out unless the owner arrives at, or calls the office. Consequently, it is a current practice of traveling businessmen to periodically call the office to check on messages. This practice is inefficient as well as costly, since at many times there would be no messages stored in the system, so that time and toll fee was wasted only to find out that there are no messages.

### SUMMARY OF THE INVENTION

The present invention aims to solve the above noted deficiency in the conventional voice mail system. Specifically, according to one aspect of the invention, whenever a message is stored in the voice mail system, the LED is lit and the system also sends a note to the owner's pager or cellular phone. When the pager or cellular phone receives the note, it activates an indication that a message is stored in the office voice mail system.

According to the preferred embodiment, when the note is received, the pager/cellular phone do not ring or activates the normal transmission reception indication, but rather activates a “silent” indication reserved specifically for voice mail indication. dr

### BRIEF DESCRIPTION OF THE DRAWINGS

FIG. 1 is a flow chart of the processing of the voice mail system according to an embodiment of the present invention.

FIG. 2 is a flow chart of the processing of the pager/cellular phone system according to an embodiment of the present invention.

FIG. 3 is a flow chart of the processing of the voice mail system according to another embodiment of the present invention.

FIG. 4 is a flow chart of the processing of the pager/cellular phone system according to another embodiment of the present invention.

FIG. 5 is a schematic diagram depicting the overall system according to an embodiment of the present invention.

### DETAILED DESCRIPTION OF THE EXEMPLARY EMBODIMENTS

In its abstract, the present invention replicates the benefits of the LED on a voice mail system, onto one's mobile communication device. As can be understood, but for the LED a voice mail system would be quite inefficient. That is, but for the LED, one would have had to check for messages constantly to ensure that no new messages were stored. However, as noted above, it is customary for traveling businessmen to periodically check their voice mail for new messages. The present invention eliminates the need for such periodic and inefficient checks.

To eliminate the guess work of checking one's voice mails, the system of the present invention “brings” the LED to the mobile user. That is, using known conventional transmission methods, the voice mail system of the present invention sends a note to the user's mobile communication device so that it would alert the user for the presence of newly recorded messages. In its simplest form, the transmission is a simple “header” type transmission which includes an “alert on” command and preferably an ID for security and verification. The “alert on” command also preferably acts as an indication to the mobile device that the transmission is not a normal incoming page/call, so that activation of the primary alert is avoided. The “primary alert” in this case refers to the normal alerts of mobile devices, such as audio and vibration in pagers and ring in cellular phones.

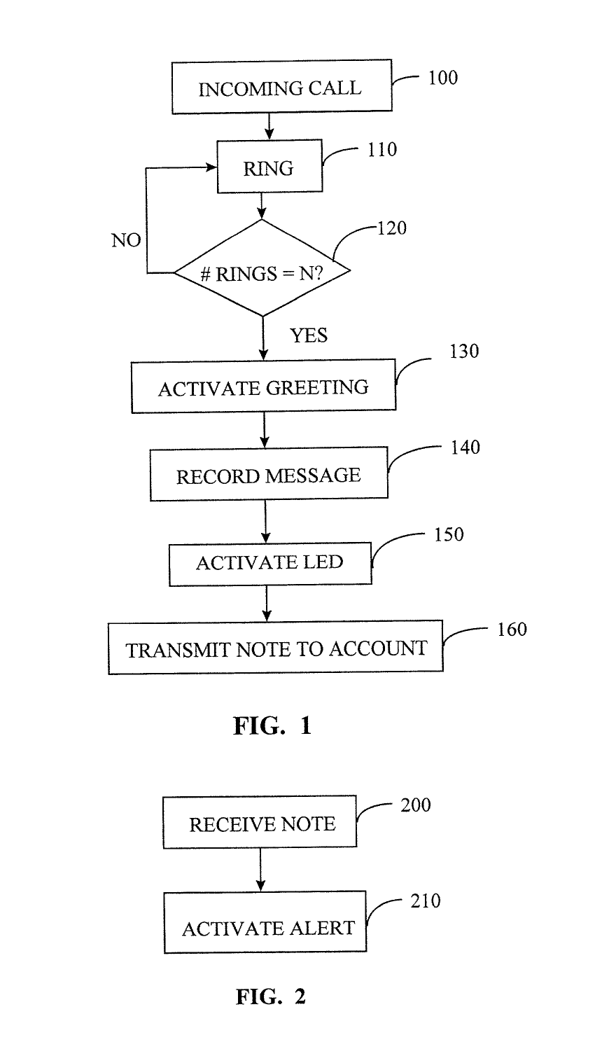

As shown in FIG. 1, when the voice mail system receives a call (100), it rings the preprogrammed number of time in a conventional manner (110, 120). That is, as is known in the art, the system can be programmed to ring a given number, N, of times before reverting to the voice mail. When the system reverts to the voice mail, it first plays a pre-recorded greeting (130). As is well known in the art, at the end of the greeting a “beep” is sound and the caller is provided the opportunity to record a message (140). After the message has been recorded, an LED is lit (150) to alert the user that a message has been recorded. In addition, according to a specially beneficial feature of the invention, the system transmits a note to the designated mobile account. Such an account may be a beeper or a cellular phone. Any conventional transmission method may be used for that purpose. In particular, the conventional method for paging upon reception of an urgent message may be used; however, it should preferably include a special “alert on” command.

More specifically, the user has to designate an account to the system. This account would generally be of a mobile unit, such as a pager or a cellular phone (including such cellular phones having a built in pager). The mobile unit is programmed to identify the note, and distinguish it from normal transmission. That is, the note may include a distinguishing “alert on” command, or other codes identifying it as being sent from the system to advice of a newly recorded message. When such a note is received (200, FIG. 2), the mobile unit activates a secondary alert (210) (such as an indication in the LCD display), but, in its default mode, it does not activate the primary alert. The user, however, may be given the option to program the mobile unit to activate both primary and secondary alerts.

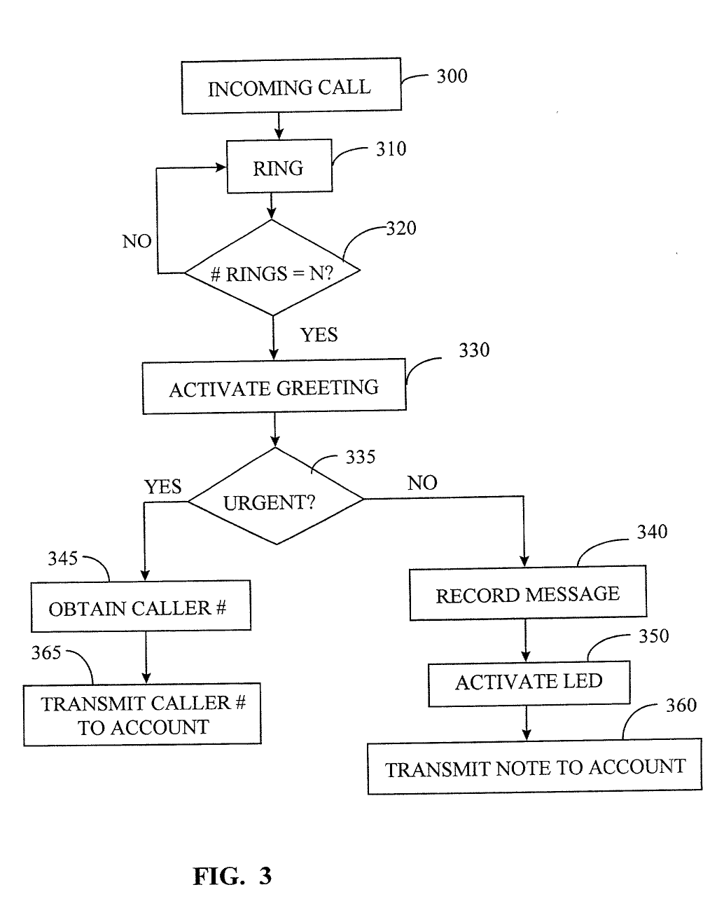

FIG. 3 is a flow chart of an embodiment of the invention as implemented in a voice mail system having an urgent call feature. As in the first embodiment, the system first checks the number of rings, and when it reaches N, plays the greeting (300-330). Then the system checks to see whether the call is urgent (for example, by checking whether the callers has dialed the “#” key)(Step 335). If so, the system receives the caller's dialed telephone number (345) and transmits it to the mobile account (365). If the call is not urgent, the system activates the message recording (340) and, when the message has been recorded, activates the system's LED (340) and send an “alert on” message to the mobile account (360).

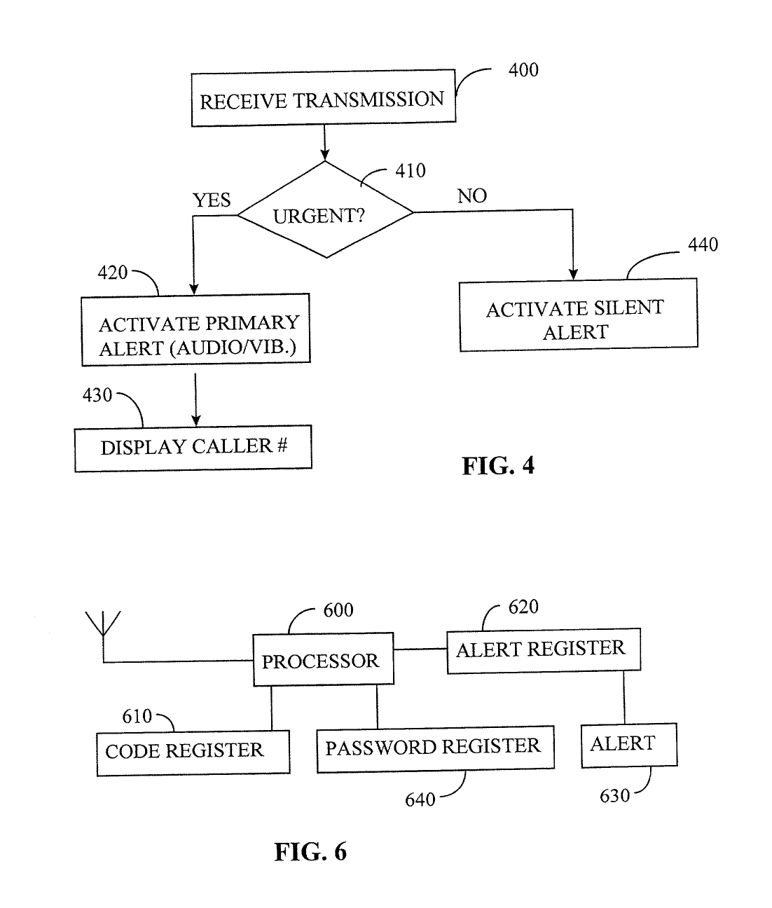

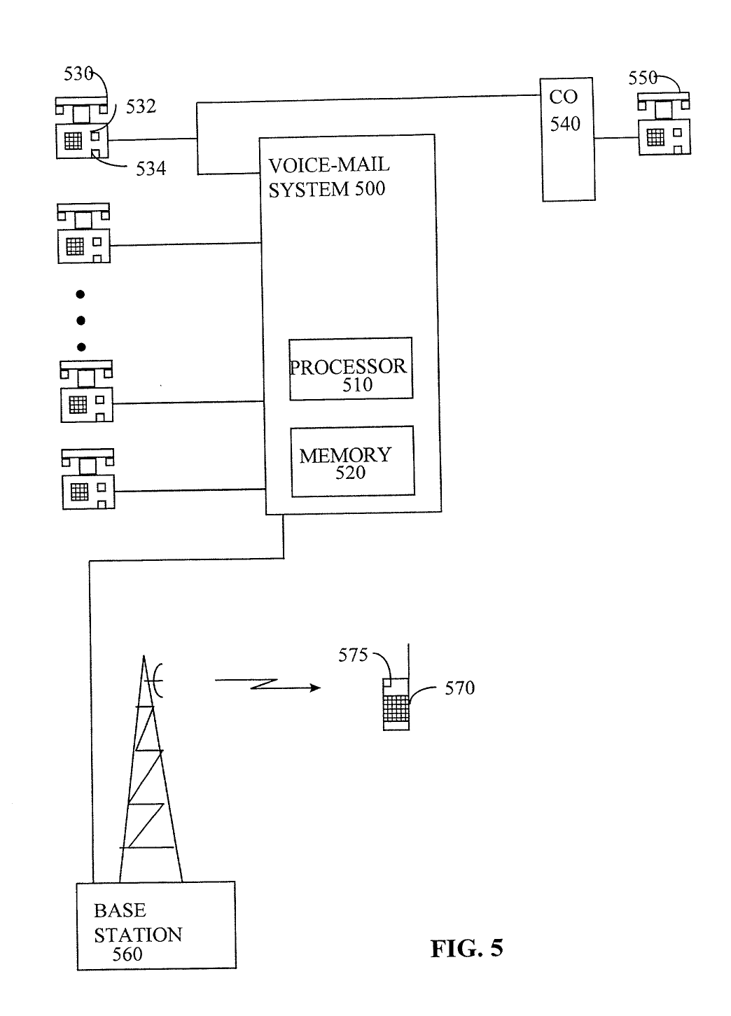

On the other hand, as shown in FIG. 4, when the mobile device receives the transmission (400), it checks whether it is an urgent transmission (410), i.e., a normal transmission such as a regular page for a pager or a normal call for a mobile phone. If the transmission is normal, the device activates the normal, primary alert (420) and, if the caller number is available, displays the caller's number (430). On the other hand, if the call is not a regular call, the mobile device activates only its silent alert (440).

Checking whether a call is regular or a message notification from the voice mail system can be done by checking for a special code inserted in the header of the call transmission. For example, it is known that when a call is originated, the called number is transmitted to the caller's Central Office (CO), which then routes the call to the called CO. Other information, such as the caller's number (for a caller ID function) can also be included in the header originating the call. For the purpose of the invention, another code can be included to indicate that the call is not a normal call, but only a notification. The simplest way of doing so is to include a “#” signal immediately following the called number. The mobile units, of course, needs to be programmed to identify and distinguish between its number, and its number followed by a “#” signal. When the number is followed by a “#” sign, the mobile unit will not operate its primary alarm, but only its secondary alarm, e.g., the mobile phone will not ring, but will only lit a message display.

According to another embodiment, the user of the mobile unit pre-programs his voice mail number into the mobile unit as the code for message alert. Thus, when the call is received, the unit checks for the caller's number. If it is any number other than the pre-programmed voice-mail number, the unit treats it as a regular call. However, if the caller's number is the same as the pre-programmed voice-mail number, this acts both as a security and verification code function, and to signify to the mobile unit that the call is only an alert that a message was recorded by the voice mail system. Thus the mobile unit does not “ring”, but only activates the voice-mail notification alarm. Of course, the mobile system may send an acknowledgment to the base station in the conventional manner.

To exemplify, assuming that the mobile unit is a cellular phone. The user enters his voice-mail number into the cellular phone's memory as a special voice-mail code. When a call is received, it is conventional for the unit to check for the called number to verify that the unit is indeed called. It is also conventional to check for the caller's number, in order to activate such features as caller ID. If the caller's number is anything other than the voice-mail code number, the cellular phone rings in the conventional manner. However, if the caller's number is the voice-mail code, the cellular phone does not ring. Instead, the cellular phone sends an acknowledgment to the base station and activates a display indicating that a message has been recorded in the voice mail system.

Preferably, the voice-mail system does not always contact the mobile unit and send the code. Instead, the system first checks to see whether it is instructed to do so. The instruction may come in several forms. For example, conventional voice-mail systems, such as those available via AT&T have an “extended absence” greeting feature, whereby the user can switch the normal greeting to an extended absence greeting. When that occurs, the system would automatically send the code to the mobile unit. Additionally, or alternatively, the system can have a dedicated on/off button for instructing the system to send the code to the mobile unit.

FIG. 5 depicts the overall system according to an embodiment of the present invention. A caller uses a telephone 550 to call one of the telephones 530 connected to the voice-mail system 500. The CO (only one is depicted for simplicity, but more can be used) recognizes the called number and routes it to the appropriate subscriber 530. When the subscriber does not answer after a pre-programmed number of rings, the call is re-routed to the voice-mail system 500. The processor 510 of the voice-mail system 500 activates a greeting stored in the memory 520 and then sounds a cue for start of recording. If the caller has not terminated the call by the time the cue is sound, the processor routes the received signal, i.e., the message, to the memory 520 for storage.

As conventionally known, when a message is recorded, the processor sends a signal to the telephone system to light the message bulb, 534, generally an LED. According to the present invention, when a message is recorded the processor also sends a code instructing a pre-designated mobile unit 570 to light its message bulb 575, generally an LED or liquid crystal display (LCD). This can be done by using conventional method of transmission to a mobile unit, such as transmitting via a base station 560. As noted above, the code can be in the form of the number of the called subscriber 530, that number plus a special key, such as the “#” key, or any other code.

FIG. 6 depicts relevant elements of a mobile unit according to an exemplary embodiment of the present invention. For the purpose of explanation, it is assumed that the mobile unit is a cellular phone. When a transmission is received, the processor 600 compares the caller's number to the number stored in the code register 610. That is, code register 610 is pre-programmed with the code which identifies a call from the voice mail system. When the number matches that stored in the code register 610, the processor 600 stores an “on” code (e.g., a binary “1”) in the alert register 620. That turns on a visual alert 630, such as an LED or LCD.

When the user originates a call from the mobile unit, the processor checks each dialed number against the password register 640. Preferably, the password register 640 stores the same password needed to obtain messages from the voice mail system. Thus, when the user dials the password to obtain messages from his voice mail system, the dialed number would match that stored in the password register 640. In such a case, the processor 600 stores an “off” code (e.g., a binary “0”) in the alert register 620. That would turn off the visual alert 630. Of course, the visual alert 630 can be turned off by a simple switch which sends an “off” code to the processor 600 or to the alert register 620.

While the invention has been described with reference to exemplary embodiment thereof, it would be appreciated by those skilled in the art that various modifications and implementations can be made without departing from the spirit and scope of the invention as defined by the appended claims.

I claim:

1. A method of operating a voice mail system, comprising:
providing a land telephone unit having a land subscriber number and having a message light;
providing a voice mail system;
providing a mobile unit having a mobile subscriber number different from said land subscriber number;
wherein:
when a caller places a call to said land telephone unit and said call has gone unanswered for a predetermined period of time, performing the following operations:
i. storing a message received from said caller in said voice mail system;
ii. turning on said message light; and,
iii. sending a message to said mobile unit indicating that a message for said land telephone unit has been stored in said voice mail system.

2. The method of claim 1, further comprising:
providing said mobile unit with a pager function; and
wherein step iii of sending a message to said mobile unit comprises paging said mobile unit.

3. The method of claim 1, further comprising the step of:
when said message is arrived at said mobile unit, activating a silent alert.

4. The method of claim 1, wherein when a call to said land telephone unit has gone unanswered for a predetermined period of time, performing the further operations of:
iv. determining whether the call is urgent;
v. if the call is urgent, sending to said mobile unit a telephone umber of said caller; and
vi. if the call is not urgent, performing steps i. ii. and iii.

5. The method of claim 1, further comprising the operations:
when a call is received at said mobile unit, determining whether said call is from said voice mail system and, if so, activating only a silent alarm, if not, activating a ring.

6. The method of claim 1, further comprising the operations:
programming said land subscriber number into said mobile unit; and,
when a call is received at said mobile unit, determining whether said call is from said land subscriber number and, if so, activating only a silent alarm, if not, activating a ring.

7. The method of claim 1, further comprising the operations:
prior to executing step iii, checking whether said land telephone unit is in an extended absence mode, if so, executing step iii, if not, halting execution of step iii.

8. A method of operating a voice mail system, comprising:
providing a voice mail system;
providing a plurality of land telephone units connected to said voice mail system, wherein each of said land telephone units has an assigned land subscriber number and has a message light;
providing a mobile unit having a mobile subscriber number different from any of said land subscriber number;
designating said mobile subscriber number to said voice mail system; and,
wherein:
when a caller places a call to identified one of said land telephone units and said call has gone unanswered for a predetermined period of time, performing the following operations:
i. storing a message received from said caller in said voice mail system;
ii. turning on said message light on said identified one of said land telephone units; and,
iii. sending a message to said mobile unit indicating that a message for said identified one of said land telephone units has been stored in said voice mail system.

9. The method of claim 8, further comprising:
providing said mobile unit with a pager function; and
wherein step iii of sending a message to said mobile unit comprises paging said mobile unit.

10. The method of claim 8, further comprising the step of:
when said message is arrived at said mobile unit, activating a silent alert.

11. The method of claim 8, wherein when a call to said identified one of said land telephone units has gone unanswered for a predetermined period of time, performing the further operations of:
iv. determining whether the call is urgent;
v. if the call is urgent, sending to said mobile unit a telephone umber of said caller; and
vi. if the call is not urgent, performing steps i. ii. and iii.

12. The method of claim 8, further comprising the operations:
when a call is received at said mobile unit, determining whether said call is from said voice mail system and, if so, activating only a silent alarm, if not, activating a ring.

13. The method of claim 8, further comprising the operations:
programming one of said land subscriber numbers into said mobile unit; and,
when a call is received at said mobile unit, determining whether said call is from said land subscriber number and, if so, activating only a silent alarm, if not, activating a ring.

14. The method of claim 8, further comprising the operations:
prior to executing step iii, checking whether said identified one of said land telephone units is in an extended absence mode, if so, executing step iii, if not, halting execution of step iii.

15. A method of operating a mobile phone, comprising:
providing said mobile unit with a silent alarm and an audible alarm;
designating said mobile unit to a voice mail system; and,
when a call is received at said mobile phone determining whether the call is from said voice mail system, if so, activating said silent alarm, if not, activating said audible alarm.

16. The method of claim 15, further comprising the steps of:
entering an account number of said voice mail system onto said mobile phone; and, wherein the step of determining comprises checking whether a caller number of said received call matches said account number.
